(19) United States
(12) Patent Application Publication
(10) Pub. No.: US 2022/0200110 A1
(43) Pub. Date: Jun. 23, 2022

(54) SECONDARY BATTERY

(71) Applicant: MURATA MANUFACTURING CO., LTD., Kyoto (JP)

(72) Inventors: Taichi KATSUMOTO, Kyoto (JP); Yoshiichi HORIKOSHI, Kyoto (JP); Masayuki KAGEYAMA, Kyoto (JP)

(21) Appl. No.: 17/690,740

(22) Filed: Mar. 9, 2022

Related U.S. Application Data
(63) Continuation of application No. PCT/JP2020/033532, filed on Sep. 4, 2020.

(30) Foreign Application Priority Data
Sep. 30, 2019 (JP) 2019-180863

(51) Int. Cl. H01M 50/547; H01M 10/0587; H01M 50/172; H01M 50/531

(52) U.S. Cl. CPC H01M 50/547; H01M 50/531; H01M 50/172; H01M 10/0587

(57) ABSTRACT

A secondary battery includes a battery device, an outer package member, and an electrode terminal. The battery device includes a positive electrode and a negative electrode. The outer package member is configured to accommodate the battery device, and has a space inside in which the battery device is not disposed. The outer package member includes no crimp part. The electrode terminal is coupled to one of the positive electrode and the negative electrode, and is provided on the outer package member to be exposed from the outer package member, with at least a portion of the electrode terminal lying inside the outer package member. In the portion of the electrode terminal lying inside the outer package member, a portion having a largest diameter is disposed inside a region overlapping the space.

### CROSS REFERENCE TO RELATED APPLICATIONS

The present application is a continuation of PCT patent application no. PCT/JP2020/033532, filed on Sep. 4, 2020, which claims priority to Japanese patent application no. JP2019-180863, filed on Sep. 30, 2019, the entire contents of which are being incorporated herein by reference.

### BACKGROUND

The present technology generally relates to a secondary battery.

Various electronic apparatuses such as mobile phones have been widely used. Such widespread use has promoted development of a secondary battery as a power source that is smaller in size and lighter in weight and allows for a higher energy density. A configuration of the secondary battery influences a battery characteristic. Accordingly, various considerations have been given to the configuration of the secondary battery.

Specifically, in order to reduce electrical resistance, a wound electrode body including a first electrode plate, a second electrode plate, and a separator is contained inside a battery case, and the first electrode plate and the second electrode plate are coupled to a shaft core via a first wound portion and a second wound portion.

In order to suppress displacement of an electrode element caused by shaking or any other cause, the electrode element (a positive electrode, a negative electrode, and a separator) in a wound form is contained inside a battery container, and the positive electrode and the negative electrode are each coupled via a lead to an electrode pole disposed between an inner wall face of the battery container and the electrode element.

In order to improve resistance to mechanical loads, an electrode-separator assembly is contained inside a housing including two housing halves that partly overlap each other.

### SUMMARY

The present technology generally relates to a secondary battery.

Various considerations have been made to solve problems of the secondary battery; however, the secondary battery has not yet achieved a sufficient energy density per unit volume, and there is still room for improvement in terms thereof.

The present technology has been made in view of such an issue and it is an object of the technology to provide a secondary battery that makes it possible to increase the energy density per unit volume.

A secondary battery according to an embodiment of the technology includes a battery device, an outer package member, and an electrode terminal. The battery device includes a positive electrode and a negative electrode. The outer package member is configured to accommodate the battery device , and has a space inside in which the battery device is not disposed. The outer package member includes no crimp part. The electrode terminal is coupled to one of the positive electrode and the negative electrode, and is provided on the outer package member to be exposed from the outer package member, with at least a portion of the electrode terminal lying inside the outer package member. In the portion of the electrode terminal lying inside the outer package member, a portion having a largest diameter is disposed inside a region overlapping the space.

According to the secondary battery of an embodiment of the present technology, the outer package member including no crimp part accommodates the battery device inside. The outer package member has a space inside in which the battery device is not disposed. The electrode terminal coupled to one of the positive electrode and the negative electrode is provided on the outer package member. At least a portion of the electrode terminal lies inside the outer package member. In the portion of the electrode terminal lying inside the outer package member, a portion having a largest diameter is disposed inside a region overlapping the space described above. This makes it possible to increase the energy density per unit volume.

It should be understood that effects of the technology are not necessarily limited to those described above and may include any of a series of effects described below in relation to the technology.

### BRIEF DESCRIPTION OF THE FIGURES

FIG. 1 is a perspective view of a configuration of a secondary battery according to an embodiment of the present technology.

FIG. 2 is an enlarged sectional view of the configuration of the secondary battery illustrated in FIG. 1.

FIG. 3 is a perspective view of a configuration of a battery device illustrated in FIG. 1.

FIG. 4 is an enlarged sectional view of a configuration of an electrode terminal illustrated in FIG. 2.

FIG. 5 is a perspective view of a configuration of a battery can to be used in a process of manufacturing the secondary battery according to an embodiment of the present technology.

FIG. 6 is a schematic sectional view of the configuration of the secondary battery illustrated in FIG. 2.

FIG. 7 is a schematic sectional view of a configuration of a secondary battery of a first comparative example.

FIG. 8 is a schematic sectional view of a configuration of a secondary battery of a second comparative example.

FIG. 9 is a schematic sectional view of a configuration of a secondary battery of a third comparative example.

FIG. 10 is a perspective view of a configuration of a secondary battery of Modification 1.

FIG. 11 is a sectional view of the configuration of the secondary battery of Modification 1 according to an embodiment of the present technology.

FIG. 12 is a perspective view of a configuration of a secondary battery of Modification 2 according to an embodiment of the present technology.

FIG. 13 is a sectional view of the configuration of the secondary battery of Modification 2 according to an embodiment of the present technology.

FIG. 14 is a sectional view of a configuration of a secondary battery of Modification 5 according to an embodiment of the present technology.

FIG. 15 is a sectional view of a configuration of a secondary battery of Modification 6 according to an embodiment of the present technology.

FIG. 16 is a sectional view of a configuration of a secondary battery of Modification 7 according to an embodiment of the present technology.

FIG. 17 is a sectional view of a configuration of a secondary battery of Modification 8 according to an embodiment of the present technology.

FIG. 18 is a perspective view of a configuration of a battery can to be used in a process of manufacturing a secondary battery of Modification 9 according to an embodiment of the present technology.

FIG. 19 is a perspective view of a configuration of a battery can to be used in a process of manufacturing a secondary battery of Modification 10 according to an embodiment of the present technology.

### DETAILED DESCRIPTION

As described herein, the present disclosure will be described based on examples with reference to the drawings, but the present disclosure is not to be considered limited to the examples, and various numerical values and materials in the examples are considered by way of example.

A description is given first of a secondary battery according to an embodiment of the technology.

Described here is a secondary battery having a flat and columnar shape. Examples of the secondary battery include a so-called coin-type secondary battery and a so-called button-type secondary battery. As will be described later, the flat and columnar secondary battery includes a pair of bottom parts and a sidewall part. The bottom parts are opposed to each other. The sidewall part lies between the bottom parts. This secondary battery has a height that is small relative to an outer diameter.

A charge and discharge principle of the secondary battery is not particularly limited. The secondary battery described below obtains a battery capacity by utilizing insertion and extraction of an electrode reactant. The secondary battery includes a positive electrode, a negative electrode, and an electrolytic solution. In the secondary battery, in order to prevent precipitation of the electrode reactant on a surface of the negative electrode in the middle of charging, a charge capacity of the negative electrode is greater than a discharge capacity of the positive electrode. In other words, an electrochemical capacity per unit area of the negative electrode is set to be greater than an electrochemical capacity per unit area of the positive electrode.

Although not limited to a particular kind, the electrode reactant is a light metal, such as an alkali metal or an alkaline earth metal. Examples of the alkali metal include lithium, sodium, and potassium. Examples of the alkaline earth metal include beryllium, magnesium, and calcium.

In the following, a description is given of an example case where the electrode reactant is lithium. A secondary battery that obtains a battery capacity by utilizing insertion and extraction of lithium is a so-called lithium-ion secondary battery. In the lithium-ion secondary battery, lithium is inserted and extracted in an ionic state.

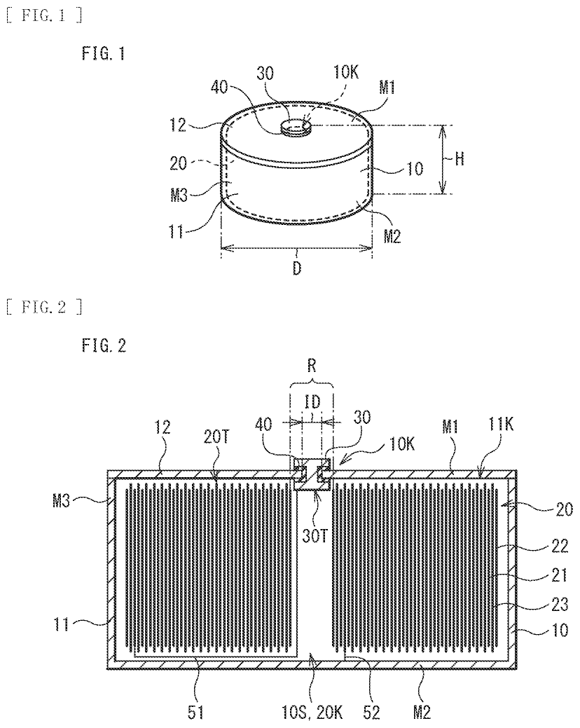

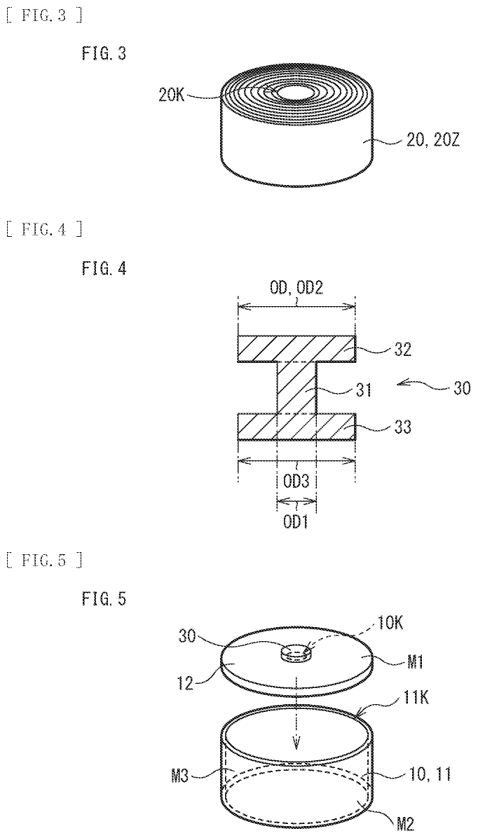

FIG. 1 is a perspective view of a configuration of the secondary battery. FIG. 2 is an enlarged sectional view of the configuration of the secondary battery illustrated in FIG. 1. FIG. 3 is a perspective view of a configuration of a battery device 20 illustrated in FIG. 1. FIG. 4 is an enlarged sectional view of a configuration of an electrode terminal 30 illustrated in FIG. 2. For simplifying the illustration, a positive electrode 21, a negative electrode 22, a separator 23, a positive electrode lead 51, and a negative electrode lead 52, which will be described later, are each illustrated in a linear shape in FIG. 2.

For convenience, the following description is given with an up direction in FIGS. 1 and 2 as an upper side of the secondary battery, and a down direction in FIGS. 1 and 2 as a lower side of the secondary battery.

The secondary battery is a button-type secondary battery, and therefore, as illustrated in FIG. 1, has a flat and columnar three-dimensional shape with a height H thereof small relative to an outer diameter D thereof. Here, the secondary battery has a flat and cylindrical (circular columnar) three-dimensional shape. Dimensions of the secondary battery are not particularly limited; however, for example, the outer diameter (here, the diameter of the circular shape) D is from 3 mm to 30 mm both inclusive, and the height H is from 0.5 mm to 70 mm both inclusive. It should be understood that a ratio of the outer diameter D to the height H, i.e., D/H, is greater than 1 and smaller than or equal to 25.

Specifically, as illustrated in FIGS. 1 and 2, the secondary battery includes a battery can 10, the battery device 20, the electrode terminal 30, a gasket 40, the positive electrode lead 51, and the negative electrode lead 52.

As illustrated in FIGS. 1 and 2, the battery can 10 is an outer package member that contains the battery device 20.

Here, the battery can 10 has a hollow, flat and cylindrical three-dimensional shape in accordance with the three-dimensional shape of the secondary battery described above. The battery can 10 thus includes a pair of bottom parts M1 and M2, and a sidewall part M3. The sidewall part M3 is coupled to the bottom part M1 at one end, and is coupled to the bottom part M2 at the other end. Because the battery can 10 is cylindrical as described above, the bottom parts M1 and M2 are each circular in plan shape, and a surface of the sidewall part M3 is a convex curved surface.

The battery can 10 includes a containing part 11 and a cover part 12. The containing part 11 is a flat and cylindrical (handleless mug-shaped) member with one end open and the other end closed. The containing part 11 contains the battery device 20. More specifically, the containing part 11 has an opening 11K at one end to allow the battery device 20 to be contained in the containing part 11. The cover part 12 is a generally plate-shaped member, and is joined to the containing part 11 to cover the opening 11K.

Here, as will be described later, the cover part 12 is joined to the containing part 11 by a method such as a welding method. More specifically, the battery can 10 is a welded can including two members (the containing part 11 and the cover part 12) welded to each other. The battery can 10 after the cover part 12 has been joined to the containing part 11 is a single member as a whole, that is, not separable into two or more members. It should be understood that the battery can 10 may be a can (a single member as a whole) including three or more members welded to each other.

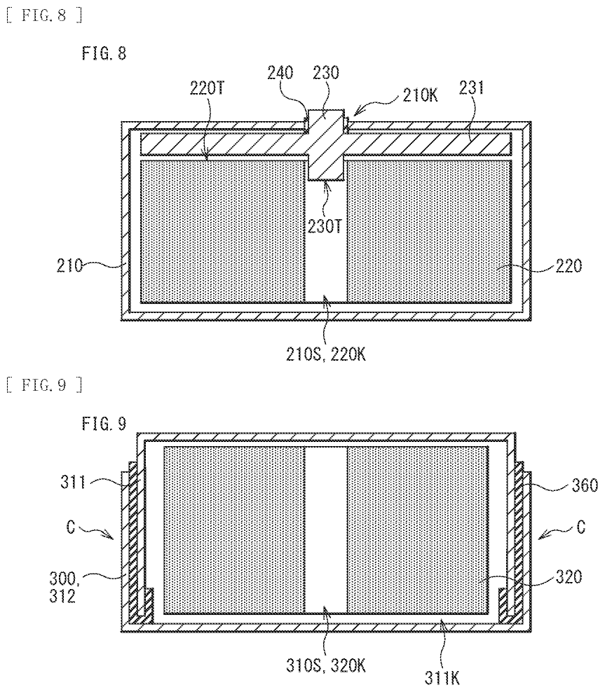

As a result, the battery can 10 is a single member including no folded-over portion or no portion in which two or more members are placed over each other. What is meant by “including no folded-over portion in the middle” is that the battery can 10 is not so processed as to include a portion folded over another portion. What is meant by “including no portion in which two or more members are placed over each other” is that the battery can 10 is physically a single member and is therefore not a composite body in which two or more members including a container and a cover are so fitted to each other as to be separable later. More specifically, the “portion in which two or more members are placed over each other” corresponds to a crimp part C provided in each of a secondary battery of a first comparative example (see FIG. 7) and a secondary battery of a third comparative example (see FIG. 9) to be described later, that is, a crimped part formed by means of a so-called crimping process. In the crimp part C of the former, a battery can 110 is crimped to a battery cover 150 with a gasket 140 interposed therebetween (FIG. 7). In the crimp part C of the latter, a containing part 311 and a cover part 312 are crimped to each other with respective portions thereof placed over each other (FIG. 9).

Thus, the battery can 10 described here is without the foregoing crimp part C, and is therefore a so-called crimpless can. A reason for employing the crimpless can is that this increases a device space volume inside the battery can 10, and accordingly, increases also the energy density per unit volume of the secondary battery. The “device space volume” refers to a volume (an effective volume) of an internal space of the battery can 10 available for containing the battery device 20 therein.

Further, the battery can 10 is electrically conductive. The battery can 10 thus serves as a negative electrode terminal because the battery can 10 is coupled to the negative electrode 22, which will be described later, of the battery device 20. A reason for employing such a configuration is that allowing the battery can 10 to serve as the negative electrode terminal makes it unnecessary to provide a negative electrode terminal separate from the battery can 10 in the secondary battery. A decrease in device space volume resulting from the presence of a negative electrode terminal is thereby avoided. This results in an increase in device space volume, and accordingly an increase in energy density per unit volume of the secondary battery.

Further, the battery can 10 has a through hole 10K at a position corresponding to a winding center space 20K to be described later. The “position corresponding to a winding center space 20K” refers to a position overlapping the winding center space 20K. The through hole 10K is used to attach the electrode terminal 30 to the battery can 10. Here, the through hole 10K is provided at the bottom part M1 and has an inner diameter ID.

The battery can 10 includes one or more of electrically conductive materials including, without limitation, metals (including stainless steel) and alloys. Here, in order to serve as the negative electrode terminal, the battery can 10 includes one or more of materials including, without limitation, iron, copper, nickel, stainless steel, an iron alloy, a copper alloy, and a nickel alloy. The kinds of the stainless steel employable include SUS304 and SUS316, but are not particularly limited thereto.

It should be understood that, as will be described later, the battery can 10 is insulated via the gasket 40 from the electrode terminal 30 serving as a positive electrode terminal. A reason for this is that a contact (a short circuit) between the battery can 10 and the electrode terminal 30 is thereby prevented.

While containing the battery device 20 inside as described above, the battery can 10 has an excess space 10S inside. The excess space 10S is, among all spaces inside the battery can 10, a space in which the battery device 20 is not disposed. The “space in which the battery device 20 is not disposed” refers to a space in which none of the components including the positive electrode 21, the negative electrode 22, and the separator 23 that contribute to charging and discharging reactions is present. Here, as will be described later, the excess space 10S is the winding center space 20K that belongs to the battery device 20 which is a wound electrode body. The excess space 10S therefore lies substantially in the middle of an inside of the battery can 10.

The battery device 20 is a device causing charging and discharging reactions to proceed, and includes, as illustrated in FIGS. 1 to 3, the positive electrode 21, the negative electrode 22, the separator 23, and an electrolytic solution which is a liquid electrolyte. It should be understood that FIGS. 2 and 3 each omit the illustration of the electrolytic solution.

The battery device 20 has a three-dimensional shape corresponding to the three-dimensional shape of the battery can 10. The “three-dimensional shape corresponding to the three-dimensional shape of the battery can 10” refers to a three-dimensional shape similar to that of the battery can 10. A reason for allowing the battery device 20 to have such a three-dimensional shape is that this makes it harder for a so-called dead space (a gap between the battery can 10 and the battery device 20) to result upon placing the battery device 20 in the battery can 10 than in a case where the battery device 20 has a three-dimensional shape different from that of the battery can 10. This allows for efficient use of the internal space of the battery can 10, resulting in an increase in device space volume, and accordingly an increase in energy density per unit volume of the secondary battery. Here, the battery can 10 has a flat and cylindrical three-dimensional shape as described above, and therefore the battery device 20 also has a flat and cylindrical three-dimensional shape.

Here, the positive electrode 21 and the negative electrode 22 are wound with the separator 23 interposed therebetween. More specifically, the positive electrode 21 and the negative electrode 22 are stacked on each other with the separator 23 interposed therebetween, and are wound in the state of the stack with the separator 23 interposed between the positive electrode 21 and the negative electrode 22. Thus, the battery device 20 is a wound electrode body including the positive electrode 21 and the negative electrode 22 that are wound with the separator 23 interposed therebetween. The number of winds of each of the positive electrode 21, the negative electrode 22, and the separator 23 is not particularly limited, and may be freely chosen.

The battery device 20 has the winding center space 20K. More specifically, the positive electrode 21, the negative electrode 22, and the separator 23 are wound in the battery device 20, and as a result, the winding center space 20K is defined at a winding core part by the positive electrode 21, the negative electrode 22, and the separator 23. Because of being at the winding core part, the winding center space 20K is a space in which none of the positive electrode 21, the negative electrode 22, and the separator 23 is present.

The battery device 20 has a top end 20T which corresponds to a first end. The top end 20T is an end lying on a rear side in a direction from the electrode terminal 30 toward an inside of the battery can 10, i.e., the down direction. More specifically, the top end 20T is an upper-side end of the battery device 20.

It should be understood that the positive electrode 21 has a height smaller than that of the separator 23. A reason for this is that this prevents a short circuit between the battery can 10 serving as the negative electrode terminal and the positive electrode 21. Although not particularly limited, a height of the negative electrode 22 is preferably larger than the height of the positive electrode 21. A reason for this is that this prevents a short circuit between the positive electrode 21 and the negative electrode 22 caused by precipitation of lithium upon charging and discharging.

The positive electrode 21 includes a positive electrode current collector and a positive electrode active material layer. The positive electrode active material layer may be provided on each of both sides of the positive electrode current collector, or may be provided only on one side of the positive electrode current collector. The positive electrode current collector includes a material similar to a material included in the electrode terminal 30. It should be understood that the material included in the positive electrode current collector may be the same as or different from the material included in the electrode terminal 30. The positive electrode active material layer includes a positive electrode active material into which lithium is insertable and from which lithium is extractable. The positive electrode active material includes one or more of lithium-containing compounds including, without limitation, a lithium-containing transition metal compound. Examples of the lithium-containing transition metal compound include an oxide, a phosphoric acid compound, a silicic acid compound, a boric acid compound, etc. each including lithium and one or more transition metal elements as constituent elements. It should be understood that the positive electrode active material layer may further include, without limitation, a positive electrode binder and a positive electrode conductor.

The negative electrode 22 includes a negative electrode current collector and a negative electrode active material layer. The negative electrode active material layer may be provided on each of both sides of the negative electrode current collector, or may be provided only on one side of the negative electrode current collector. The negative electrode current collector includes a material similar to the material included in the battery can 10. It should be understood that the material included in the negative electrode current collector may be the same as or different from the material included in the battery can 10. The negative electrode active material layer includes a negative electrode active material into which lithium is insertable and from which lithium is extractable. The negative electrode active material includes one or more of materials including, without limitation, a carbon material and a metal-based material. Examples of the carbon material include graphite. The metal-based material is a material that includes, as a constituent element or constituent elements, one or more elements among metal elements and metalloid elements that are each able to form an alloy with lithium. Specifically, the metal-based material includes one or more of elements including, without limitation, silicon and tin, as a constituent element or constituent elements. The metal-based material may be a simple substance, an alloy, a compound, or a mixture of two or more thereof. It should be understood that the negative electrode active material layer may further include, without limitation, a negative electrode binder and a negative electrode conductor.

The separator 23 is an insulating porous film interposed between the positive electrode 21 and the negative electrode 22. The separator 23 allows lithium to pass therethrough while preventing a short circuit between the positive electrode 21 and the negative electrode 22. This separator 23 includes one or more of polymer compounds, including polyethylene.

The positive electrode 21, the negative electrode 22, and the separator 23 are each impregnated with the electrolytic solution. The electrolytic solution includes a solvent and an electrolyte salt. The solvent includes one or more of nonaqueous solvents (organic solvents) including, without limitation, a carbonic-acid-ester-based compound, a carboxylic-acid-ester-based compound, and a lactone-based compound. The electrolyte salt includes one or more of light metal salts, including a lithium salt.

It should be understood that FIG. 3 also illustrates a wound body 20Z to be used to fabricate the battery device 20 in a process of manufacturing the secondary battery to be described later. The wound body 20Z has a configuration similar to that of the battery device 20, which is a wound electrode body, except that the positive electrode 21, the negative electrode 22, and the separator 23 are each yet to be impregnated with the electrolytic solution.

The electrode terminal 30 is an external coupling terminal to be coupled to an electronic apparatus on which the secondary battery is mountable. Here, as illustrated in FIGS. 1, 2, and 4, the electrode terminal 30 is coupled to the positive electrode 21 (the positive electrode current collector) of the battery device 20. The electrode terminal 30 thus serves as the positive electrode terminal. As a result, upon use of the secondary battery, the secondary battery is coupled to the electronic apparatus via the electrode terminal 30 (the positive electrode terminal) and the battery can 10 (the negative electrode terminal), and the electronic apparatus thereby becomes operable using the secondary battery as a power source.

The electrode terminal 30 includes one or more of electrically conductive materials including, without limitation, metals (including stainless steel) and alloys. Here, in order to serve as the positive electrode terminal, the electrode terminal 30 includes one or more of materials including, without limitation, aluminum, an aluminum alloy, and stainless steel.

Further, the electrode terminal 30 has a bottom end 30T which corresponds to a second end. The bottom end 30T is an end lying on a front side in the direction from the electrode terminal 30 toward the inside of the battery can 10 , and more specifically, is a lower-side end of the electrode terminal 30.

The electrode terminal 30 is provided on the battery can 10, and has an outer diameter OD. More specifically, the electrode terminal 30 is so provided in the through hole 10K, which is provided in the battery can 10, as to be exposed from the battery can 10. A reason for this is that this enables the electrode terminal 30 to be coupled to the electronic apparatus upon use of the secondary battery.

In this secondary battery, in particular, the electrode terminal 30 is optimized in terms of configuration, that is, a positional relationship between the electrode terminal 30 and the battery device 20, in order to achieve a greatest possible energy density per unit volume of the secondary battery by achieving a greatest possible device space volume.

Specifically, providing the through hole 10K at a position overlapping the winding center space 20K, i.e., the excess space 10S, results in the electrode terminal 30 being disposed inside a region R overlapping the winding center space 20K. What is meant by “disposed inside a region R overlapping the winding center space 20K” is that, when the secondary battery is viewed from the rear side in the direction from the electrode terminal 30 toward the inside of the battery can 10, that is, when the battery can 10 and the electrode terminal 30 are viewed from above, an entirety of the electrode terminal 30 is disposed inside the region R overlapping the winding center space 20K, and therefore no portion of the electrode terminal 30 is outside the region R.

A portion of the electrode terminal 30 lies inside the battery can 10, more specifically, lies inside the winding center space 20K, which is the excess space 10S. As a result, the remaining portion of the electrode terminal 30, i.e., a portion other than the foregoing portion, protrudes outwardly from the battery can 10. In this case, the bottom end 30T of the electrode terminal 30 lies forward of the top end 20T of the battery device 20 in the direction toward the inside of the battery can 10; in other words, the bottom end 30T lies below the top end 20T.

As a result, in the portion of the electrode terminal 30 lying inside the battery can 10, a portion having a largest diameter (i.e., a maximum value of the outer diameter OD described later) is disposed inside the region R. The portion of the electrode terminal 30 lying inside the battery can 10 is thus disposed only inside the region R and not outside the region R.

A description will be given later of a detailed reason why the above-described configuration (positional relationship between the electrode terminal 30 and the battery device 20) results in an increase in device space volume.

The three-dimensional shape of the electrode terminal 30 is not particularly limited. Here, the electrode terminal 30 includes terminal parts 31, 32, and 33. The terminal parts 32 and 33 are coupled to respective opposite ends of the terminal part 31.

The terminal part 31 is a first terminal part having a cylindrical shape and disposed in the through hole 10K. The terminal part 31 has an outer diameter OD (OD1) smaller than the inner diameter ID of the through hole. The terminal part 32 is a second terminal part having a cylindrical shape, and is coupled to the terminal part 31 on the rear side in the direction from the electrode terminal 30 toward the inside of the battery can 10, that is, on the upper side in FIG. 4. The terminal part 32 has an outer diameter OD (OD2) larger than the inner diameter ID of the through hole 10K. The terminal part 33 is a third terminal part having a cylindrical shape, and is coupled to the terminal part 31 on the front side in the direction from the electrode terminal 30 toward the inside of the battery can 10, that is, on the lower side in FIG. 4. The terminal part 33 has an outer diameter OD (OD3) larger than the inner diameter ID of the through hole 10K. It should be understood that the outer diameters OD2 and OD3 may be equal, or may be different from each other. Here, the outer diameters OD2 and OD3 are equal.

Thus, the electrode terminal 30 has a generally cylindrical three-dimensional shape with the outer diameter OD reduced partly along the direction from the electrode terminal 30 toward the inside of the battery can 10. A reason for employing such a shape is that the outer diameter OD2 of the terminal part 32 larger than the inner diameter ID of the through hole 10K helps to prevent the terminal part 32 from passing through the through hole 10K, and the outer diameter OD3 of the terminal part 33 larger than the inner diameter ID of the through hole 10K helps to prevent the terminal part 33 from passing through the through hole 10K. A further reason is that the electrode terminal 30 is fixed to the battery can 10 by utilizing a pressing force of the terminal part 32 on the battery can 10 and a pressing force of the terminal part 33 on the battery can 10. This helps to prevent the electrode terminal 30 from falling out of the battery can 10.

The gasket 40 is an insulating member disposed between the battery can 10 and the electrode terminal 30, as illustrated in FIGS. 1 and 2. The gasket 40 insulates the electrode terminal 30 from the battery can 10. The electrode terminal 30 is thus fixed to the battery can 10 with the gasket 40 interposed therebetween.

The gasket 40 includes one or more of insulating materials including, without limitation, polypropylene and polyethylene.

A mounting range of the gasket 40 is not particularly limited. Here, the gasket 40 is disposed only in a gap between the battery can 10 and the electrode terminal 30.

As illustrated in FIG. 2, the positive electrode lead 51 is a coupling wiring line coupling the electrode terminal 30 and the positive electrode 21 to each other, and includes a material similar to the material included in the electrode terminal 30. It should be understood that the material included in the positive electrode lead 51 may be the same as or different from the material included in the electrode terminal 30.

To couple the electrode terminal 30 and the positive electrode 21 to each other, the positive electrode lead 51 extends through an inside of the winding center space 20K, i.e., the excess space 10S. More specifically, one end of the positive electrode lead 51 is coupled to the positive electrode 21 (the positive current collector). The other end of the positive electrode lead 51 is coupled to the electrode terminal 30 as the positive electrode lead 51 extends from the positive electrode 21 to the electrode terminal 30 via the winding center space 20K. A reason for this is that this prevents a decrease in device space volume resulting from the presence of the positive electrode lead 51, thus resulting in an increase in the device space volume.

A coupling position of the positive electrode lead 51 to the positive electrode 21 is not particularly limited, and may be freely chosen. Here, the positive electrode lead 51 is coupled to the positive electrode 21 on a side of an outermost wind.

At each of ends of the positive electrode 21 on an inner side and an outer side of winding, the positive electrode active material layer is not provided on the positive electrode current collector, and the positive electrode current collector is thus exposed. In other words, the positive electrode 21 has a foil winding structure in which only the positive electrode current collector is wound at each of the ends on the inner side and the outer side of the winding. Here, the positive electrode lead 51 is coupled to an end of the positive electrode current collector on the outer side of the winding. However, the positive electrode lead 51 may be coupled to the positive electrode current collector at a position other than the end on the outer side of the winding.

The number of the positive electrode leads 51 is not particularly limited. As the number of the positive electrode leads 51 increases, electrical resistance of the secondary battery (the battery device 20) decreases. Needless to say, even if the number of the positive electrode leads 51 increases, the presence of each of the positive electrode leads 51 causes no decrease in device space volume as long as the positive electrode leads 51 each extend through the winding center space 20K. Here, the secondary battery is provided with one positive electrode lead 51.

As illustrated in FIG. 2, the negative electrode lead 52 couples the battery can 10 and the negative electrode 22 to each other. The negative electrode lead 52 includes a material similar to the material included in the battery can 10. It should be understood that the material included in the negative electrode lead 52 may be the same as or different from the material included in the battery can 10.

A coupling position of the negative electrode lead 52 to the negative electrode 22 is not particularly limited, and may be freely chosen. Here, the negative electrode lead 52 is coupled to the negative electrode 22 on a side of an innermost wind.

At each of ends of the negative electrode 22 on the inner side and the outer side of the winding, the negative electrode active material layer is not provided on the negative electrode current collector, and the negative electrode current collector is thus exposed. In other words, the negative electrode 22 has the foil winding structure in which only the negative electrode current collector is wound at each of the ends on the inner side and the outer side of the winding. Here, the negative electrode lead 52 is coupled to an end of the negative electrode current collector on the inner side of the winding. However, the negative electrode lead 52 may be coupled to the negative electrode current collector at a position other than the end on the inner side of the winding.

It should be understood that the secondary battery may further include one or more of other unillustrated components.

Specifically, the secondary battery includes a safety valve mechanism. The safety valve mechanism cuts off the electrical coupling between the battery can 10 and the battery device 20 if an internal pressure of the battery can 10 reaches a certain level or higher due to, e.g., an internal short circuit or heating from outside. Although a mounting position of the safety valve mechanism is not particularly limited, the safety valve mechanism is provided at one of the bottom parts M1 and M2, preferably the bottom part M2 at which the electrode terminal 30 is not provided.

Further, the secondary battery includes an insulator between the battery can 10 and the battery device 20. The insulator includes one or more of materials including, without limitation, an insulating film and an insulating sheet, and prevents a short circuit between the battery can 10 and the battery device 20 (the positive electrode 21). A mounting range of the insulator is not particularly limited, and may be freely chosen.

It should be understood that the battery can 10 is provided with, for example, a liquid injection hole and a cleavage valve. The liquid injection hole is used for injecting the electrolytic solution into the battery can 10, and is sealed after use. In a case where the internal pressure of the battery can 10 reaches a certain level or higher due to, e.g., an internal short circuit or heating from outside as described above, the cleavage valve cleaves to release the internal pressure. Although there is no limitation on the respective positions at which the liquid injection hole and the cleavage valve are to be provided, the liquid injection hole and the cleavage valve are each provided at one of the bottom parts M1 and M2, preferably the bottom part M2 at which the electrode terminal 30 is not provided, as with the mounting position of the safety valve mechanism described above.

The secondary battery operates in a manner described below. Upon charging, in the battery device 20, lithium is extracted from the positive electrode 21, and the extracted lithium is inserted into the negative electrode 22 via the electrolytic solution. Upon discharging, in the battery device 20, lithium is extracted from the negative electrode 22, and the extracted lithium is inserted into the positive electrode 21 via the electrolytic solution. In these cases, the lithium is inserted and extracted in an ionic state.

FIG. 5 is a perspective view of the configuration of the battery can 10 to be used in a process of manufacturing the secondary battery, and corresponds to FIG. 1. It should be understood that FIG. 5 illustrates a state where the cover part 12 is separated from the containing part 11. In the following, FIGS. 1 to 4 described already will be referred to when necessary.

In a case of manufacturing the secondary battery, the secondary battery is assembled by a procedure described below. In this case, the wound body 20Z described above is used to fabricate the battery device 20, and the cover part 12 with the electrode terminal 30 attached thereto with the gasket 40 therebetween in advance is used to assemble the battery can 10.

First, prepared is a slurry including, without limitation, the positive electrode active material in a solvent such as an organic solvent, following which the slurry is applied on the positive electrode current collector to thereby form the positive electrode active material layer. The positive electrode 21 including the positive electrode current collector and the positive electrode active material layer is thereby fabricated.

Thereafter, prepared is a slurry including, without limitation, the negative electrode active material in a solvent such as an organic solvent, following which the slurry is applied on the negative electrode current collector to thereby form the negative electrode active material layer. The negative electrode 22 including the negative electrode current collector and the negative electrode active material layer is thereby fabricated.

Thereafter, the electrolyte salt is added to a solvent. The electrolytic solution including the solvent and the electrolyte salt is thereby prepared.

Thereafter, the positive electrode 21 and the negative electrode 22 are stacked on each other with the separator 23 interposed therebetween, following which the stack of the positive electrode 21, the negative electrode 22, and the separator 23 is wound to thereby fabricate the wound body 20Z having the winding center space 20K.

Thereafter, the wound body 20Z is placed into the containing part 11 through the opening 11K. In this case, one end of the negative electrode lead 52 is coupled to the wound body 20Z (the negative electrode current collector of the negative electrode 22) and the other end of the negative electrode lead 52 is coupled to the battery can 10 by a method such as a welding method. It should be understood that one or more of welding methods including, without limitation, a laser welding method and a resistance welding method may be used. Details of the welding method described here apply also to the following.

Thereafter, the cover part 12 with the electrode terminal 30 attached thereto with the gasket 40 therebetween in advance is placed on the containing part 11 to cover the opening 11K, following which the cover part 12 is joined to the containing part 11 by a method such as a welding method. In this case, one end of the positive electrode lead 51 is coupled to the wound body 20Z (the positive electrode current collector of the positive electrode 21) and the other end of the positive electrode lead 51 is coupled to the electrode terminal 30 by a method such as a welding method. The wound body 20Z is thereby sealed into the battery can 10 (the containing part 11 and the cover part 12).

Lastly, the electrolytic solution is injected into the battery can 10 through the unillustrated liquid injection hole, following which the liquid injection hole is sealed. In this case, the winding center space 20K is used to retain the electrolytic solution, allowing for injection of a necessary and sufficient amount of the electrolytic solution into the battery can 10. This causes the wound body 20Z (the positive electrode 21, the negative electrode 22, and the separator 23) to be impregnated with the electrolytic solution, thereby fabricating the battery device 20. The battery device 20 is thus sealed into the battery can 10. As a result, the secondary battery is completed.

According to the secondary battery, the crimpless battery can 10 including no crimp part C contains the battery device 20 inside, and the battery can 10 has the excess space 10S (the winding center space 20K) inside. The battery can 10 is provided with the electrode terminal 30 coupled to the positive electrode 21 of the battery device 20. A portion of the electrode terminal 30 lies inside the battery can 10. In the portion of the electrode terminal 30 lying inside the battery can 10, a portion having a largest diameter is disposed inside the region R overlapping the excess space 10S. As a result, for a reason described below, it is possible to increase the energy density per unit volume.

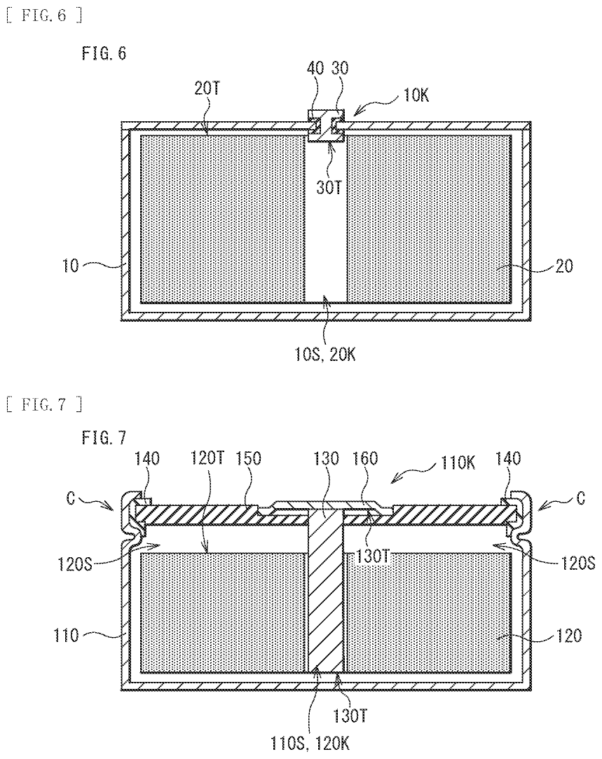

FIG. 6 schematically illustrates a sectional configuration of the secondary battery of the present embodiment illustrated in FIG. 2. FIG. 7 schematically illustrates a sectional configuration of a secondary battery of a first comparative example, and corresponds to FIG. 6. FIG. 8 schematically illustrates a sectional configuration of a secondary battery of a second comparative example, and corresponds to FIG. 6. FIG. 9 schematically illustrates a sectional configuration of a secondary battery of a third comparative example, and corresponds to FIG. 6.

The secondary battery of the first comparative example has a configuration as illustrated in FIG. 7. Specifically, as illustrated in FIG. 7, the secondary battery of the first comparative example includes the battery can 110 (an excess space 110S), a battery device 120 (a winding center space 120K and a top end 120T), a positive electrode shaft core 130 (a bottom end 130T), and the gasket 140 that respectively correspond to the battery can 10 (the excess space 10S), the battery device 20 (the winding center space 20K and the top end 20T), the electrode terminal 30 (the bottom end 30T), and the gasket 40. In addition, the secondary battery of the first comparative example includes the battery cover 150 and a safety valve 160.

The battery can 110 is a hollow and generally handleless mug-shaped member with one end open and the other end closed, and has an opening 110K at the one end. The positive electrode shaft core 130 is provided in the entire winding center space 120K without being exposed at the opening 110K. Therefore, the bottom end 130T of the positive electrode shaft core 130 lies forward of the top end 120T of the battery device 120 in the direction toward the inside of the battery can 110. Although not illustrated here, in the battery device 120, the positive electrode (the positive electrode current collector) is coupled to the positive electrode shaft core 130 via a coupling wiring line for the positive electrode, and the negative electrode (the negative electrode current collector) is coupled to the battery can 110 via a coupling wiring line for the negative electrode.

The battery cover 150 is disposed on the opening 110K to cover the opening 110K. The safety valve 160 is coupled to the positive electrode shaft core 130. The battery cover 150 is exposed at the opening 110K instead of the positive electrode shaft core 130, thus serving as the positive electrode terminal. The gasket 140 is interposed between the battery can 110 and the battery cover 150, thus insulating the battery cover 150 from the battery can 110. The battery can 110 is crimped to the battery cover 150 with the gasket 140 interposed therebetween in the vicinity of the opening 110K, and the battery cover 150 is thus fixed to the battery can 110 with the gasket 140 interposed therebetween. The crimp part C is thereby provided at a location where the battery cover 150 is held by the battery can 110 in the vicinity of the opening 110K.

The secondary battery of the second comparative example has a configuration as illustrate in FIG. 8. Specifically, as illustrated in FIG. 8, the secondary battery of the second comparative example includes a battery can 210 (a through hole 210K and an excess space 210S), a battery device 220 (a winding center space 220K and a top end 220T), a positive electrode column 230 (a bottom end 230T), and a gasket 240 that respectively correspond to the battery can 10 (the opening 11K and the excess space 10S), the battery device 20 (the winding center space 20K and the top end 20T), the electrode terminal 30 (the bottom end 30T), and the gasket 40.

The battery can 210 is a crimpless can including no crimp part C (see FIG. 7) described above. Although not illustrated here, in the battery device 220, the positive electrode (the positive electrode current collector) is coupled to the positive electrode column 230 via a coupling wiring line for the positive electrode, and the negative electrode (the negative electrode current collector) is coupled to the battery can 210 via a coupling wiring line for the negative electrode. The positive electrode column 230 is disposed in the through hole 210K provided in the battery can 210, and is exposed at the through hole 210K.

A portion of the positive electrode column 230 lies inside the winding center space 220K of the battery device 220, and the bottom end 230T of the positive electrode column 230 thus lies forward of the top end 220T of the battery device 220 in the direction toward the inside of the battery can 210. The positive electrode column 230 includes two (left and right) extension parts 231 extending in a space between an inner wall face of the battery can 210 and the battery device 220. The gasket 240 is disposed between the battery can 210 and the positive electrode column 230 in the through hole 210K, thus insulating the positive electrode column 230 from the battery can 210.

The secondary battery of the third comparative example has a configuration as illustrated in FIG. 9. Specifically, as illustrated in FIG. 9, the secondary battery of the third comparative example includes a battery can 310 (the containing part 311, the cover part 312, and an excess space 310S) and a battery device 320 (a winding center space 320K) that respectively correspond to the battery can 10 (the excess space 10S) and the battery device 20 (the winding center space 20K). In addition, the secondary battery of the third comparative example includes a gasket 360.

The containing part 311 is a hollow and generally handleless mug-shaped member with one end open and the other end closed, and has an opening 311K at the one end. The battery device 320 is contained in the containing part 311. The cover part 312 is disposed on the opening 311K, and the containing part 311 is thus covered by the cover part 312. In this case, the containing part 311 and the cover part 312 are crimped to each other with the gasket 360 interposed therebetween in a state in which a portion of the containing part 311 and a portion of the cover part 312 are placed over each other with the gasket 360 interposed therebetween. Thus, the crimp part C is provided at a location where the portion of the containing part 311 and the portion of the cover part 312 are placed over each other.

Here, the device space volumes are compared between the secondary battery of the present embodiment (FIG. 6), the secondary battery of the first comparative example (FIG. 7), the secondary battery of the second comparative example (FIG. 8), and the secondary battery of the third comparative example (FIG. 9). In this case, it is assumed that the secondary batteries are equal in outer diameter D (maximum outer diameter) and equal in height H (maximum height), and that the respective winding center spaces 20K, 120K, 220K, and 320K of the secondary batteries are equal in inner diameter.

In the secondary battery of the first comparative example, as illustrated in FIG. 7, the positive electrode shaft core 130 is not exposed at the opening 110K of the battery can 110, and instead, the gasket 140 and the battery cover 150 are disposed on the opening 110K. The crimp part C is provided to fix the battery cover 150.

In this case, even if the internal space defined by the battery can 110 itself is large in volume, a practical volume (an effective volume) of the internal space available for containing the battery device 120 in the battery can 110 is smaller by a volume occupied by the crimp part C. As a result, in the battery device 120, the positive electrode and the negative electrode are each smaller in height, and therefore an area over which the positive electrode and the negative electrode are opposed to each other is also smaller. The device space volume thus decreases, and accordingly, the energy density per unit volume of the secondary battery also decreases. This makes it difficult to obtain a superior battery characteristic such as a superior capacity characteristic.

In the secondary battery of the second comparative example, as illustrated in FIG. 8, the extension parts 231 of the positive electrode column 230 are disposed between the inner wall face of the battery can 210 and the battery device 220.

In this case, even if the internal space defined by the battery can 210 itself is large in volume, the effective volume available for containing the battery device 220 in the battery can 210 is smaller by a volume occupied by the extension parts 231 in the battery can 210. As a result, in the battery device 220, the positive electrode and the negative electrode are each smaller in height, and therefore the area over which the positive electrode and the negative electrode are opposed to each other is also smaller, as with the secondary battery (the battery device 120) of the first comparative example. The device space volume thus decreases, and accordingly, the energy density per unit volume of the secondary battery also decreases.

In the secondary battery of the third comparative example, as illustrated in FIG. 9, the crimp part C is provided to fix the containing part 311 and the cover part 312 to each other.

In this case, the effective volume available for containing the battery device 320 in the battery can 310 is smaller by a volume occupied by the crimp part C. As a result, in the battery device 320, the number of winds of each of the positive electrode and the negative electrode is smaller, and therefore the area over which the positive electrode and the negative electrode are opposed to each other is also smaller. The device space volume thus decreases, and accordingly, the energy density per unit volume of the secondary battery also decreases.

In contrast, as illustrated in FIG. 6, the secondary battery of the present embodiment is provided with no crimp part C. Moreover, although a portion of the electrode terminal 30 lies inside the battery can 10, the entire portion lying inside the battery can 10 is disposed inside the region R overlapping the excess space 10S (the winding center space 20K). In other words, inside the battery can 10, the portion of the electrode terminal 30 is disposed inside the winding center space 20K which is originally a dead space. In this case, even if the electrode terminal 30 for external coupling is used, the effective volume available for containing the battery device 20 in the battery can 10 hardly decreases relative to the volume of the internal space defined by the battery can 10 itself. This allows the positive electrode 21 and the negative electrode 22 to be opposed to each other over a larger area.

Moreover, the electrode terminal 30 is exposed from the battery can 10 for its intended use to establish external coupling. This obviates the need for an additional member, such as the battery cover 150, for coupling the secondary battery to an electronic apparatus, that is, a member that results in a smaller effective volume inside the battery can 10. As a result, also in terms of external coupling of the secondary battery, the effective volume hardly decreases relative to the volume of the internal space defined by the battery can 10 itself.

In view of the above, the secondary battery of the present embodiment achieves an increased device space volume, allowing for an increase in energy density per unit area of the secondary battery, as compared with each of the secondary battery of the first comparative example, the secondary battery of the second comparative example, and the secondary battery of the third comparative example. Accordingly, it is possible to obtain a superior battery characteristic such as a superior capacity characteristic.

In this case, in particular, because a portion of the electrode terminal 30 is placed inside the winding center space 20K, the battery device 20 is fixed inside the battery can 10 by means of the electrode terminal 30. This helps to prevent the battery device 20 from becoming out of alignment. Accordingly, it is possible to manufacture the secondary battery easily and stably, and is also possible to secure stable charging and discharging operations after the manufacture of the secondary battery.

Further, the secondary battery has a flat and columnar shape, in other words, the secondary battery is a small-sized secondary battery, such as a coin-type or button-type secondary battery. Even in the small-sized secondary battery which is highly constrained in terms of size, energy density per unit volume effectively increases. Accordingly, it is possible to achieve higher effects.

In addition, in the secondary battery of the present embodiment, the bottom end 30T of the electrode terminal 30 may lie below the top end 20T of the battery device 20. This allows the device space volume to be secured even if the electrode terminal 30 for external coupling is used. Accordingly, it is possible to achieve higher effects.

Further, the battery can 10 may be a crimpless can including no crimp part C. This prevents a decrease in effective volume resulting from the presence of the crimp part C. As a result, the device space volume is securable more easily, and it is thus possible to achieve higher effects. In this case, the battery can 10 may be a welded can. This makes it easy to provide the battery can 10 including no crimp part C. Accordingly, it is possible to achieve higher effects.

Further, a portion of the electrode terminal 30 may protrude from the battery can 10. This makes it easier to couple the secondary battery to an electronic apparatus by means of the electrode terminal 30 while securing the device space volume. Accordingly, it is possible to achieve higher effects.

Further, the electrode terminal 30 may include the terminal part 31 having a small outer diameter (OD1) and the terminal parts 32 and 33 having large outer diameters (OD2 and OD3). This helps to prevent the electrode terminal 30 from falling out of the battery can 10. Accordingly, stable charging and discharging operations of the secondary battery are secured while the device space volume is secured. It is thus possible to achieve higher effects.

Further, the battery device 20 may have a three-dimensional shape corresponding to the three-dimensional shape of the battery can 10. This helps to prevent a dead space from resulting upon placing the battery device 20 in the battery can 10, thereby facilitating efficient use of the effective volume inside the battery can 10. Accordingly, an area over which the positive electrode 21 and the negative electrode 22 are opposed to each other is secured. It is thus possible to achieve higher effects.

Further, the positive electrode lead 51 coupling the electrode terminal 30 and the positive electrode 21 to each other may pass through the winding center space 20K, i.e., the excess space 10S. In such a case, no decrease in effective volume results even if the positive electrode lead 51 is used. Accordingly, it is possible to achieve higher effects. In this case, in particular, a space for providing the positive electrode lead 51 between the battery can 10 and the battery device 20 is minimized, and therefore a gap between the battery can 10 and the battery device 10 is minimized. This allows for a sufficient increase in area over which the positive electrode 21 and the negative electrode 22 are opposed to each other, making it possible to achieve higher effects also from this regard.

Further, the negative electrode 22 may be coupled to the battery can 10. This allows the battery can 10 to serve as the negative electrode terminal, making it unnecessary to separately provide a negative electrode terminal in the secondary battery. Accordingly, a decrease in effective volume due to the presence of the negative electrode terminal is avoided, and it is thus possible to achieve higher effects. In this case, the gasket 40 may be disposed between the battery can 10 and the electrode terminal 30. This prevents a short circuit between the electrode terminal 30 and the battery can 10 also in the case where the battery can 10 serves as the negative electrode terminal. Accordingly, stable charging and discharging operations of the secondary battery are secured even if the battery can 10 is used as the negative electrode terminal. It is thus possible to achieve higher effects.

For the secondary battery of the present embodiment (FIG. 6), the secondary battery of the first comparative example (FIG. 7), the secondary battery of the second comparative example (FIG. 8), and the secondary battery of the third comparative example (FIG. 9), the respective device space volumes (mm³) were logically (mathematically) calculated, and the calculated device space volumes were compared with each other. Table 1 provides the results obtained.

The “Configuration” column in Table 1 indicates the kinds of the secondary batteries. More specifically, “Comparative 1” represents the secondary battery of the first comparative example. “Comparative 2” represents the secondary battery of the second comparative example. “Comparative 3” represents the secondary battery of the third comparative example. “Embodiment” represents the secondary battery of the present embodiment.

Conditions for calculating the device space volumes were as follows. The battery cans 10, 110, 210, and 310 are each hollow and cylindrical in three-dimensional shape, therefore defining a cylindrical internal space to contain relevant one of the battery devices 20, 120, 220, and 320 therein. Multiple dimensions, i.e., the outer diameter (mm), the outer height (mm), the inner diameter (mm), and the inner height (mm) of each of the battery cans 10, 110, 210, and 310 were set as listed in Table 1. Here, for simplifying comparison, no consideration was given to any influence of the volume of each of the winding center spaces 20K, 120K, 220K, and 320K on the device space volume. In other words, for convenience, the volume of each of the winding center spaces 20K, 120K, 220K, and 320K was included in the device space volume.

Here, the outer diameter refers to a maximum diameter, i.e., the outer diameter D, of each of the battery cans 10, 110, 210, and 310 having a cylindrical shape. The outer height refers to a maximum height, i.e., the height H, of each of the battery cans 10, 110, 210, and 310. The inner diameter refers to a maximum diameter of the internal space of each of the battery cans 10, 110, 210, and 310. The inner height refers to a maximum height of the internal space.

The secondary battery of the present embodiment includes the electrode terminal 30. The secondary battery of the first comparative example includes the positive electrode shaft core 130 corresponding to the electrode terminal 30. The secondary battery of the second comparative example includes the positive electrode column 230 corresponding to the electrode terminal 30. The secondary battery of the third comparative example includes no component corresponding to the electrode terminal 30.

Multiple dimensions, that is, the outer diameter (mm) and the height (mm), of each of the electrode terminal 30, the positive electrode shaft core 130, and the positive electrode column 230 were set as listed in Table 1.

Here, the outer diameter refers to a maximum diameter of each of the electrode terminal 30, the positive electrode shaft core 130, and the positive electrode column 230. The height refers to a maximum height of each of the electrode terminal 30, the positive electrode shaft core 130, and the positive electrode column 230.

A thickness (a wall thickness) of each of the battery cans 10, 110, 210, and 310 was set to 0.15 mm. A thickness of the gasket 360 was set to 0.2 mm.

To calculate the device space volume, first, a maximum volume of the internal space (the cylindrical space), that is, a space volume (mm³), of each of the battery cans 10, 110, 210, and 310 was calculated. Thereafter, a volume of a space unavailable for containing relevant one of the battery devices 20, 120, 220, and 320 in the internal space, that is, a loss volume (mm³), was calculated. In this case, as described above, the volume of each of the winding center spaces 20K, 120K, 220K, and 320K was excluded from the loss volume. Lastly, the loss volume was subtracted from the space volume to thereby calculate the device space volume. As listed in Table 1, the multiple dimensions (i.e., the outer diameter, the outer height, the inner diameter, and the inner height) of each of the battery cans 10, 110, 210, and 310 were varied into five different value combinations.

It should be understood that the space volume of each of the battery cans 10, 110, 210, and 310, that is, the volume of the internal space defined by relevant one of the battery cans 10, 110, 210, and 310, is determined on the basis of the inner diameter and the inner height. Accordingly, in a case where the battery cans 10, 110, 210, and 310 are given equal inner diameters and equal inner heights, the respective space volumes of the battery cans 10, 110, 210, and 310 become equal.

TABLE 1

| | | | | | Electrode terminal Positive electrode | | | | |
|---|---|---|---|---|---|---|---|---|---|
| | Battery can | | | | shaft core Positive electrode column | | | | |
| | Outer | Outer | Inner | Inner | Outer | | Space | Loss | Device space |
| | diameter | height | diameter | height | diameter | Height | volume | volume | volume |
| Configuration | (mm) | (mm) | (mm) | (mm) | (mm) | (mm) | (mm³) | (mm³) | (mm³) |
| Comparative 1 | 8 | 5.5 | 7.7 | 5.2 | 4 | 2 | 242 | 93 | 149 |
| Comparative 2 | | | 7.7 | | 6.7 | 2 | 242 | 93 | 149 |
| Comparative 3 | | | 7.1 | | — | — | 242 | 36 | 206 |
| Embodiment | | | 7.7 | | 4 | 2 | 242 | 25 | 217 |
| Comparative 1 | 12 | 5.5 | 11.7 | 5.2 | 4 | 2 | 559 | 215 | 344 |
| Comparative 2 | | | 11.7 | | 10.7 | 2 | 559 | 215 | 344 |
| Comparative 3 | | | 11.1 | | — | — | 559 | 56 | 503 |
| Embodiment | | | 11.7 | | 4 | 2 | 559 | 25 | 534 |
| Comparative 1 | 16 | 5.5 | 15.7 | 5.2 | 4 | 2 | 1007 | 387 | 619 |
| Comparative 2 | | | 15.7 | | 14.7 | 2 | 1007 | 387 | 619 |
| Comparative 3 | | | 15.1 | | — | — | 1007 | 75 | 931 |
| Embodiment | | | 15.7 | | 4 | 2 | 1007 | 25 | 982 |
| Comparative 1 | 12 | 3 | 11.7 | 2.7 | 4 | 2 | 290 | 215 | 75 |
| Comparative 2 | | | 11.7 | | 10.7 | 2 | 290 | 215 | 75 |
| Comparative 3 | | | 11.1 | | — | — | 290 | 29 | 261 |
| Embodiment | | | 11.7 | | 4 | 2 | 290 | 25 | 265 |
| Comparative 1 | 12 | 8 | 11.7 | 7.7 | 4 | 2 | 828 | 215 | 613 |
| Comparative 2 | | | 11.7 | | 10.7 | 2 | 828 | 215 | 613 |
| Comparative 3 | | | 11.1 | | — | — | 828 | 83 | 745 |
| Embodiment | | | 11.7 | | 4 | 2 | 828 | 25 | 803 |

As indicated in Table 1, the device space volume varied depending on the configuration of the secondary battery.

In the secondary battery of the first comparative example, the crimp part C is provided through the use of a large-sized member such as the battery cover 150, and the loss volume is thus mainly a volume of the cylindrical space occupied by the crimp part C. As described above, the presence of the large-sized member such as the battery cover 150 results in an excessively large loss volume. Accordingly, the device space volume decreases significantly.

In the secondary battery of the first comparative example, in particular, if a plurality of coupling wiring lines is disposed between the battery device 120 and the gasket 140 in order to couple the battery device 120 (a plurality of positive electrodes) and the positive electrode shaft core 130 to each other via the plurality of coupling wiring lines, the loss volume increases further by a volume occupied by the plurality of coupling wiring lines. Accordingly, the device space volume decreases further.

In the secondary battery of the second comparative example, the positive electrode column 230, which is a large-sized member, is contained inside the battery can 210, and the positive electrode column 230 has the extension parts 231. Accordingly, the loss volume is mainly a volume of the cylindrical space occupied by the extension parts 231. The presence of the large-sized member, i.e., the extension parts 231, results in an excessively large loss volume. Accordingly, the device space volume decreases significantly, as with the device space volume of the secondary battery of the first comparative example.

In the secondary battery of the third comparative example, the crimp part C is provided through the use of a thin member such as the gasket 140, and the loss volume is thus mainly a volume of the hollow cylindrical space occupied by the crimp part C. The presence of the thin member such as the gasket 140 allows the loss volume to be smaller than that in each of the secondary battery of the first comparative example and the secondary battery of the second comparative example. However, the loss volume is still large and accordingly, the device space volume still decreases.

In contrast, the secondary battery of the present embodiment is provided with no crimp part C. Moreover, although a portion of the electrode terminal 30 is contained inside the battery can 10, the entire portion lying inside the battery can 10 is disposed inside the region R. Therefore, no loss volume results from the presence of the electrode terminal 30. This makes the loss volume even smaller than that in the secondary battery of the third comparative example. The loss volume is thus sufficiently reduced, and accordingly, the device space volume sufficiently increases.

The results presented in Table 1 indicate that the secondary battery of the present embodiment achieves a reduced loss volume, and accordingly an increased device space volume as compared with each of the secondary battery of the first comparative example, the secondary battery of the second comparative example, and the secondary battery of the third comparative example.

Next, modifications of the foregoing secondary battery will be described. The configuration of the secondary battery is appropriately modifiable, as will be described below. It should be understood that any two or more of the following series of modifications may be combined.

### Modifications 1 and 2

In FIG. 2, the electrode terminal 30 protrudes from the battery can 10, with a portion of the electrode terminal 30 disposed inside the winding center space 20K, i.e., the excess space 10S. However, the positional relationship between the electrode terminal 30 and the battery device 20 is not particularly limited as long as a portion or the entirety of the electrode terminal 30 is disposed inside the winding center space 20K.

Specifically, the electrode terminal 30 may be shifted to a position more forward in the direction toward the inside of the battery can 10 to thereby bring the entirety of the electrode terminal 30 inside the battery can 10 with no portion thereof protruding from the battery can 10.

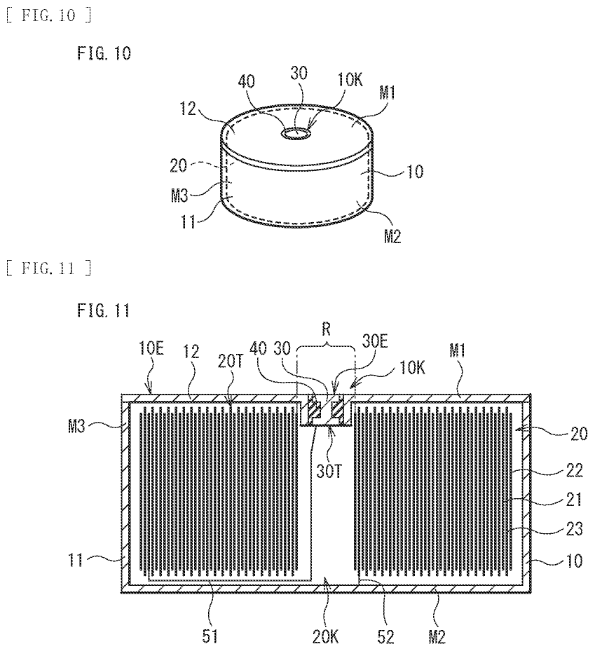

In this case, as illustrated in FIG. 10 corresponding to FIG. 1, and FIG. 11 corresponding to FIG. 2, the battery can 10 may be recessed in part, and a portion of the electrode terminal 30 may be disposed inside the winding center space 20K. In addition, a top end 30E of the electrode terminal 30 and a top end 10E of the battery can 10 may be at the same position in the direction from the electrode terminal 30 toward the inside of the battery can 10. In other words, the top ends 10E and 30E may be, as it is called, flush with each other (Modification 1).

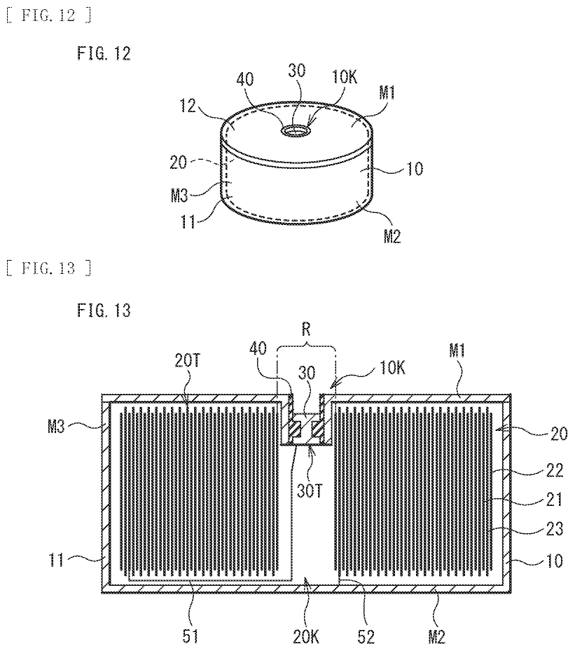

Alternatively, as illustrated in FIG. 12 corresponding to FIG. 1, and FIG. 13 corresponding to FIG. 2, the battery can 10 may be recessed in part, and the entirety of the electrode terminal 30 may be disposed inside the winding center space 20K. In addition, the electrode terminal 30 may be recessed from the surface of the battery can 10 (Modification 2).

In both cases of Modifications 1 and 2, by adjusting the mounting range of the gasket 40 in accordance with the position of the electrode terminal 30, it is possible to insulate the electrode terminal 30 from the battery can 10 by means of the gasket 40.

In these cases, the position of the electrode terminal 30 is changed only within the region R corresponding to the winding center space 20K, and therefore the change in the position of the electrode terminal 30 causes no change in the device space volume. As a result, the device space volume increases, making it possible to achieve similar effects.

According to Modifications 1 and 2, in particular, the secondary battery decreases in height H because the electrode terminal 30 does not protrude from the battery can 10 but lies inside the battery can 10. It is thus possible to downsize the secondary battery. However, to make it easier to couple the secondary battery (the electrode terminal 30) to an electronic apparatus, Modification 1 (FIGS. 10 and 11) is preferable to Modification 2 (FIGS. 12 and 13), and the present embodiment (FIGS. 1 and 2) is preferable to Modification 1.

### Modification 3

In FIG. 2, the battery device 20 (the positive electrode 21) and the electrode terminal 30 are coupled to each other via a single positive electrode lead 51. However, although not illustrated here, the number of the positive electrode leads 51 is not particularly limited, and may be two or more. In other words, the battery device 20 and the electrode terminal 30 may be coupled to each other via two or more positive electrode leads 51.

In this case also, the device space volume increases and it is thus possible to achieve similar effects. In this case, in particular, the two or more positive electrode leads 51 may be allowed to pass through the inside of the winding center space 20K. This prevents the device space volume from decreasing due to an increase in the number of the positive electrode leads 51. Accordingly, it is possible to achieve higher effects.

### Modification 4

In FIG. 4, the electrode terminal 30 includes the terminal parts 31 to 33 having mutually different outer diameters OD, i.e., the outer diameters OD1 to OD3. Accordingly, the outer diameter OD of the electrode terminal 30 varies along the direction from the electrode terminal 30 toward the inside of the battery can 10. However, as described above, the three-dimensional shape of the electrode terminal 30 is not particularly limited, and is freely changeable.

Specifically, although not illustrated here, the electrode terminal 30 may include only the terminal parts 31 and 32 without the terminal part 33, or may include only the terminal parts 31 and 33 without the terminal part 32. Alternatively, the electrode terminal 30 may have a substantially uniform outer diameter OD as a whole, and therefore the outer diameter OD of the electrode terminal 30 may be constant along the direction from the electrode terminal 30 toward the inside of the battery can 10.

In these cases also, the device space volume increases, making it possible to achieve similar effects.

### Modification 5

In FIGS. 2 and 4, the terminal parts 31 to 33 of the electrode terminal 30 all have a cylindrical three-dimensional shape, and therefore the electrode terminal 30 as a whole has a generally cylindrical three-dimensional shape. However, the three-dimensional shape of each of the terminal parts 31 to 33 is not particularly limited as long as the electrode terminal 30 is able to serve as the positive electrode terminal. Specifically, the terminal parts 31 to 33 may each have another three-dimensional shape, such as a shape of a polygonal prism, and the electrode terminal 30 as a whole may thus have another, generally polygonal prismatic three-dimensional shape. The polygonal prism is not particularly limited, and examples thereof include a triangular prism, a rectangular prism, and a pentagonal prism. In this case also, the device space volume increases, making it possible to achieve similar effects.

### Modification 6

In FIG. 2, while the electrode terminal 30 protrudes from the battery can 10, a portion of the electrode terminal 30 is disposed inside the winding center space 20K. In this case, a proportion of the portion of the electrode terminal 30 to be disposed inside the winding center space 20K, that is, how far into the winding center space 20K the portion of the electrode terminal 30 is to extend, is not particularly limited.

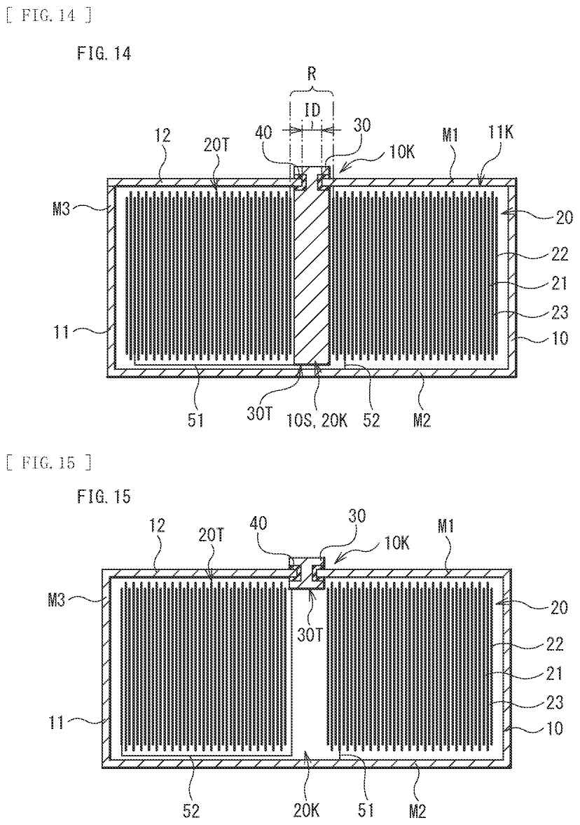

Specifically, as illustrated in FIG. 14 corresponding to FIG. 2 in conjunction with FIG. 4, the terminal part 33 may be extended in the direction from the electrode terminal 30 toward the inside of the battery can 10, and a portion of the electrode terminal 30 may thus be disposed in the entire inside of the winding center space 20K.

In this case, a location range of the terminal part 33 is changed only within the region R corresponding to the winding center space 20K, and therefore the change in the location range of the terminal part 33 causes no change in the device space volume. As a result, the device space volume increases, making it possible to achieve similar effects.

### Modification 7

In FIG. 2, the electrode terminal 30 is coupled to the battery device 20 (the positive electrode 21) via the positive electrode lead 51, and the battery device 20 (the negative electrode 22) is coupled to the battery can 10 via the negative electrode lead 52. Thus, the electrode terminal 30 serves as the positive electrode terminal, and the battery can 10 serves as the negative electrode terminal.

However, as illustrated in FIG. 15 corresponding to FIG. 2, the electrode terminal 30 may be coupled to the battery device 20 (the negative electrode 22) via the negative electrode lead 52, and the battery device 20 (the positive electrode 21) may be coupled to the battery can 10 via the positive electrode lead 51. Thus, the electrode terminal 30 may serve as the negative electrode terminal, and the battery can 10 may serve as the positive electrode terminal.

In this case, in order to serve as the negative electrode terminal, the electrode terminal 30 includes one or more of materials including, without limitation, iron, copper, nickel, stainless steel, an iron alloy, a copper alloy, and a nickel alloy. In order to serve as the positive electrode terminal, the battery can 10 includes one or more of materials including, without limitation, aluminum, an aluminum alloy, and stainless steel.

In this case also, it is possible to couple the secondary battery to an electronic apparatus by means of the electrode terminal 30 (the negative electrode terminal) and the battery can 10 (the positive electrode terminal) while securing the device space volume. Accordingly, it is possible to achieve similar effects.

### Modification 8

In FIG. 2, the battery device 20 is a wound electrode body, and the positive electrode 21 and the negative electrode 22 are thus wound with the separator 23 interposed therebetween. However, the device structure of the battery device 20 is not particularly limited.

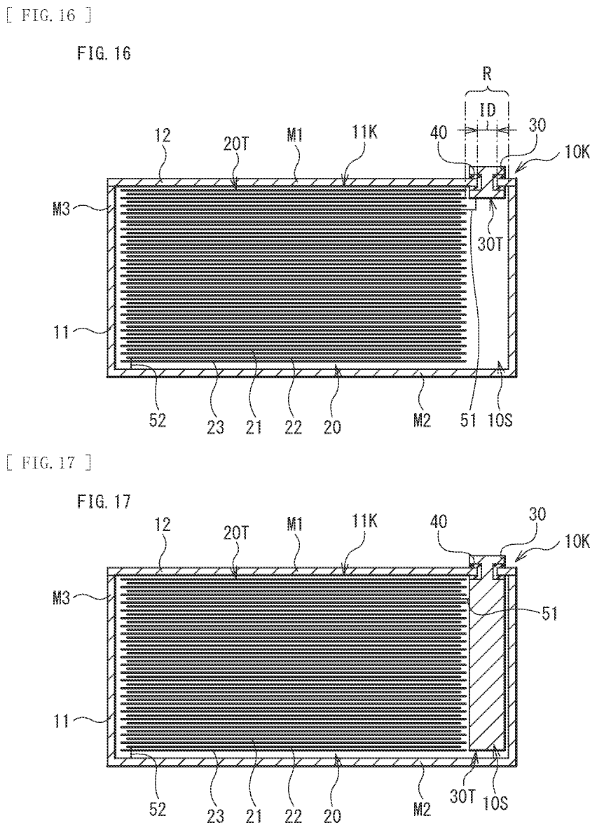

Specifically, as illustrated in FIG. 16 corresponding to FIG. 2, the battery device 20 may be a stacked electrode body in which the positive electrode 21 and the negative electrode 22 are stacked on each other with the separator 23 interposed therebetween. The battery device 20 as the stacked electrode body has a configuration similar to that of the battery device 20 as the wound electrode body, except that a plurality of positive electrodes 21 and a plurality of negative electrodes 22 are alternately stacked with the separators 23 interposed therebetween.

In this case, the excess space 10S that the battery can 10 has inside is not the winding center space 20K but a space for a coupling wiring line in which the positive electrode lead 51 is to be disposed. The excess space 10S lies at an end, which is the right end here, of the inside of the battery can 10. Accordingly, the electrode terminal 30 is shifted in position to be disposed at a position overlapping the excess space 10S.

In this case also, the electrode terminal 30 is disposed inside the region R corresponding to the excess space 10S; therefore, the electrode terminal 30 does not affect the device space volume. As a result, the device space volume increases, making it possible to achieve similar effects.

### Modification 9

In Modification 8 described above, as has been described in foregoing Modification 6, the proportion of the portion of the electrode terminal 30 to be disposed inside the excess space 10S is not particularly limited.

Specifically, as illustrated in FIG. 17 corresponding to FIG. 16 in conjunction with FIG. 4, the terminal part 33 may be extended in the direction from the electrode terminal 30 toward the inside of the battery can 10, and a portion of the electrode terminal 30 may thus be disposed in the entire inside of the excess space 10S. In this case also, it is possible to achieve effects similar to those of Modification 5.

### Modifications 10 and 11

In FIG. 5, the battery can 10 includes the containing part 11 and the cover part 12. The containing part 11 and the cover part 12 are welded to each other. However, the configuration of the battery can 10 is not particularly limited as long as the battery can 10 is a crimpless can that is able to contain the battery device 20 while supporting the electrode terminal 30.

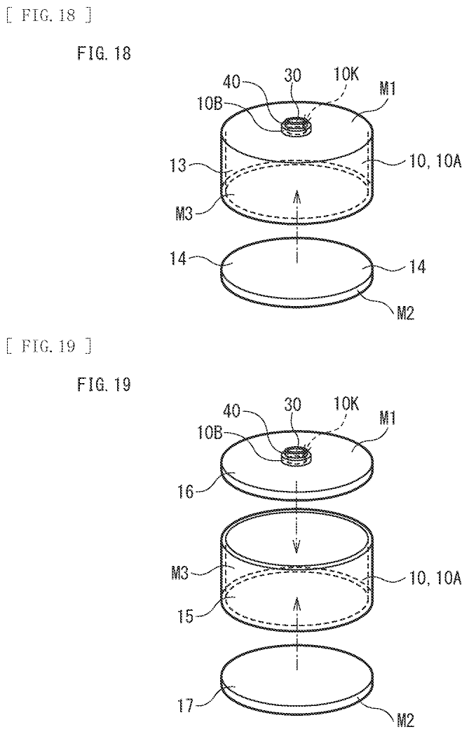

Specifically, as illustrated in FIG. 18 corresponding to FIG. 5, the battery can 10 may include a containing part 13 and a bottom part 14 in place of the containing part 11 and the cover part 12. The containing part 13 is a flat and cylindrical (generally handleless mug-shaped) member with one end open and the other end closed. The containing part 13 includes the electrode terminal 30 provided in the through hole 10K with the gasket 40 interposed therebetween. The bottom part 14 is a generally plate-shaped member. Thus, the battery can 10 described here is a welded can including two members (the containing part 13 and the bottom part 14) that are welded to each other.

In a case of fabricating the secondary battery using this battery can 10 including the containing part 13 and the bottom part 14, the wound body 20Z is placed into the containing part 13 and thereafter the bottom part 14 is joined to the containing part 13 by a method such as a welding method. A fabrication procedure of the secondary battery is otherwise similar to that of the secondary battery using the battery can including the containing part 11 and the cover part 12.

Alternatively, as illustrated in FIG. 19 corresponding to FIG. 5, the battery can 10 may include a containing part 15, a cover part 16, and a bottom part 17 in place of the containing part 11 and the cover part 12. The containing part 15 is a flat and cylindrical (generally handleless mug-shaped) member with both ends open. The cover part 16 is a generally plate-shaped member including the electrode terminal 30 provided in the through hole 10K with the gasket 40 interposed therebetween. The bottom part 17 is a generally plate-shaped member. Thus, the battery can 10 described here is a welded can including three members (the containing part 15, the cover part 16, and the bottom part 17) that are welded to each other.

In a case of fabricating the secondary battery using this battery can 10 including the containing part 15, the cover part 16, and the bottom part 17, the wound body 20Z is placed into the containing part 15 and thereafter the cover part 16 and the bottom part 17 are each joined to the containing part 15 by a method such as a welding method. A fabrication procedure of the secondary battery is otherwise similar to that of the secondary battery using the battery can including the containing part 11 and the cover part 12.

In this case also, the battery can 10 is able to contain the battery device 20 inside. Accordingly, it is possible to achieve similar effects.

### Modification 12

The positive electrode lead 51 may be physically separated from the positive electrode current collector and thereby provided as a component separate from the positive electrode current collector. Alternatively, the positive electrode lead 51 may be physically coupled to the positive electrode current collector and thereby integrated with the positive electrode current collector. In the latter case, in a process of forming the positive electrode 21 by means of a punching process on a metal foil, the positive electrode current collector after forming the positive electrode active material layer thereon may be punched into a configuration in which the positive electrode lead 51 and the positive electrode current collector are integrated with each other. It is thereby possible to form the positive electrode 21 including the positive electrode current collector integrated with the positive electrode lead 51. In this case also, electrical conduction between the positive electrode lead 51 and the positive electrode current collector is secured. Accordingly, it is possible to achieve similar effects.

It should be understood that, in a case where the positive electrode lead 51 is integrated with the positive electrode current collector, the positive electrode 21 need not have a foil winding structure, and therefore the positive electrode active material layer may be provided on the entire positive electrode current collector. In other words, the positive electrode current collector does not have to be exposed at each of the ends of the positive electrode 21 on the inner side and the outer side of the winding.

Modification 12 described here is also applicable to the negative electrode lead 52 and the negative electrode current collector. More specifically, the negative electrode lead 52 may be separate from the negative electrode current collector or may be integrated with the negative electrode current collector. In this case also, electrical conduction between the negative electrode lead 52 and the negative electrode current collector is secured. Accordingly, it is possible to achieve similar effects. Needless to say, in a case where the negative electrode lead 52 is integrated with the negative electrode current collector, the negative electrode 22 need not have the foil winding structure, and the negative electrode active material layer may thus be provided on the entire negative electrode current collector.

### Modification 13

In the process of manufacturing the secondary battery, the wound body 20Z is placed into the containing part 11, and the cover part 12 is joined to the containing part 11 by a method such as a welding method, following which the electrolytic solution is injected into the battery can 10 (the containing part 11 and the cover part 12) through the liquid injection hole. In other words, the wound body 20Z is impregnated with the electrolytic solution by injecting the electrolytic solution into the battery can 10 after the battery can 10 is formed, that is, after the cover part 12 is joined to the containing part 11.

However, the cover part 12 may be joined to the containing part 11 by a method such as a welding method after the wound body 20Z is placed into the containing part 11 and the electrolytic solution is injected into the containing part 11. In other words, the wound body 20Z may be impregnated with the electrolytic solution by injecting the electrolytic solution into the containing part 11 before the battery can 10 is formed, that is, before the cover part 12 is joined to the containing part 11. In this case, the battery can 10 does not have to be provided with a liquid injection hole.

In this case also, the battery device 20 is fabricated by impregnation of the wound body 20Z with the electrolytic solution, and the battery device 20 is sealed inside the battery can 10. Accordingly, it is possible to achieve similar effects. In this case, in particular, it is possible to simplify the configuration of the battery can 10 because it is unnecessary for the battery can 10 to have a liquid injection hole. Further, because the electrolytic solution is injected into the containing part 11 through the opening 11K having an opening area larger than that of the liquid injection hole, it is possible to improve efficiency of injection of the electrolytic solution for the wound body 20Z, and to simplify the process of injecting the electrolytic solution.

Although the technology has been described above with reference to some embodiments and examples, configurations of the technology are not limited to those described with reference to the embodiments and examples above, and are therefore modifiable in a variety of ways.

Specifically, while a description has been given of a case of using a liquid electrolyte (an electrolytic solution), the electrolyte is not limited to a particular kind. Thus, a gel electrolyte (an electrolyte layer) may be used, or an electrolyte in a solid form (a solid electrolyte) may be used.

Further, while a description has been given of a case where the electrode reactant is lithium, the electrode reactant is not particularly limited. Specifically, the electrode reactant may be, as described above, another alkali metal, such as sodium or potassium, or may be an alkaline earth metal, such as beryllium, magnesium, or calcium. Other than the above, the electrode reactant may be another light metal, such as aluminum.

The effects described herein are mere examples. Therefore, the effects of the technology are not limited to the effects described herein. Accordingly, the technology may achieve any other effect.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A secondary battery comprising:
a battery device including a positive electrode and a negative electrode;
an outer package member configured to accommodate the battery device, wherein the outer package member includes a space inside in which the battery device is not disposed, and includes no crimp part; and
an electrode terminal coupled to one of the positive electrode and the negative electrode, and provided on the outer package member to be exposed from the outer package member, with at least a portion of the electrode terminal lying inside the outer package member,
wherein, in the portion of the electrode terminal lying inside the outer package member, a portion having a largest diameter is disposed inside a region overlapping the space.

2. The secondary battery according to claim 1, wherein
the battery device has a first end lying on a rear side in a direction from the electrode terminal toward an inside of the outer package member,
the electrode terminal has a second end lying on a front side in the direction from the electrode terminal toward the inside of the outer package member, and
the second end lies on the front side relative to the first end in the direction from the electrode terminal toward the inside of the outer package member.

3. The secondary battery according to claim 1, wherein the outer package member includes no folded-over portion or no portion in which two members are placed over each other.

4. The secondary battery according to claim 2, wherein the outer package member includes no folded-over portion or no portion in which two members are placed over each other.

5. The secondary battery according to claim 3, wherein the outer package member includes two or more members that are welded to each other.

6. The secondary battery according to claim 1, wherein a portion of the electrode terminal protrudes from the outer package member.

7. The secondary battery according to claim 2, wherein a portion of the electrode terminal protrudes from the outer package member.

8. The secondary battery according to claim 3, wherein a portion of the electrode terminal protrudes from the outer package member.

9. The secondary battery according to claim 4, wherein a portion of the electrode terminal protrudes from the outer package member.

10. The secondary battery according to claim 5, wherein a portion of the electrode terminal protrudes from the outer package member.

11. The secondary battery according to claim 1, wherein an entirety of the electrode terminal is disposed inside the outer package member.

12. The secondary battery according to claim 1, wherein
the outer package member has a through hole, and
the electrode terminal includes
a first terminal part disposed in the through hole and having an outer diameter smaller than an inner diameter of the through hole, and
a second terminal part and a third terminal part that are coupled to respective ends of the first terminal part that are opposite in a direction from the electrode terminal toward an inside of the outer package member, wherein the second terminal part and the third terminal part each have an outer diameter larger than the inner diameter of the through hole.

13. The secondary battery according to claim 1, wherein the battery device has a three-dimensional shape corresponding to a three-dimensional shape of the outer package member.

14. The secondary battery according to claim 1, wherein
the battery device further includes a separator, and
the positive electrode and the negative electrode are wound with the separator interposed therebetween.

15. The secondary battery according to claim 1, wherein
the battery device further includes a separator, and
the positive electrode and the negative electrode are stacked on each other with the separator interposed therebetween.

16. The secondary battery according to claim 1, further comprising one or more coupling wiring lines that pass through an inside of the space and couple the one of the positive electrode and the negative electrode to the electrode terminal.

17. The secondary battery according to claim 1, wherein another of the positive electrode and the negative electrode is coupled to the outer package member.

18. The secondary battery according to claim 17, further comprising an insulating member disposed between the outer package member and the electrode terminal.

19. The secondary battery according to claim 1, wherein the secondary battery includes a flat and columnar secondary battery.
